(19) United States
(12) Patent Application Publication
(10) Pub. No.: US 2018/0057657 A1
(43) Pub. Date: Mar. 1, 2018

(54) Method and System for the Recycling and Reuse of Coal Ash

(71) Applicant: WIlliam T. Hall, Hope Mills, NC (US)

(72) Inventor: WIlliam T. Hall, Hope Mills, NC (US)

(21) Appl. No.: 15/686,772

(22) Filed: Aug. 25, 2017

Related U.S. Application Data
(60) Provisional application No. 62/379,911, filed on Aug. 26, 2016.

(51) Int. Cl. C08K 3/22; C08K 3/36; C08K 3/00; C08J 11/06

(52) U.S. Cl. CPC C08K 3/22; C08K 3/36; C08K 3/0008; C08K 2003/2265; C08K 2003/2206; C08K 2003/2227; C08J 11/06

(57) ABSTRACT

A method for the reuse of coal composition products and a resultant material are disclosed. The method generally utilizes the steps of heating a plastic component to a melting point, adding a predetermined quantity of coal combustion products to the melted plastic, mixing, and cooling the mixture to a solid state. Preferably the end product of the mixture is comprised of 75% recycled plastic and 25% coal combustion products.

### CROSS REFERENCE TO RELATED APPLICATIONS

This application claims priority to U.S. Provisional Patent Application No. 62/379,911 filed 26 Aug. 2016 to the above named inventor, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present invention relates to a method for the recycling of coal ash and resulting product for use in plastic products.

### BACKGROUND OF THE INVENTION

Coal ash is the residual byproduct produced from the combustion of coal. More generically this coal ash can be placed within the category of coal combustion waste or coal combustion products (CCPs) from the burning of coal. CCPs are generally the solids collected from a coal burning furnace and flue after the coal is burned. These CCPs can include coal ash (fly ash and bottom ash), boiler slag, and flue gas desulphurization products. The lightweight solid form of coal ash is referred to as fly ash and heavier particles are called bottom ash.

These CCPs contain several substances depending upon the type of coal burned and are often disposed of in landfills or mixed with water in coal ash ponds. The typical composition of CCPs is 90% oxides of silicon, aluminum, iron and calcium. In addition to these materials, CCPs may have a variety of heavy metals and metalloids, including arsenic, lead, mercury, chromium, and selenium. The disposal of CCPs causes some environmental concerns and industry is often seeking new and unique ways to reuse or recycle CCPs, and in particular coal ash.

In addition to CCPs, consumer plastic waste is an additional source of pollution. Plastics are made from a wide variety of chemicals and primarily originate from petrochemicals. Most plastics belong to the following group of: polyester (PES), polyethylene terephthalate (PET), polyethylene (PE), high density polyethylene (HDPE), poly vinyl chloride (PVC), polyvinylidene chloride (PVDC), low density polyethylene (LDPE), polypropylene (PP), polystyrene (PS), high impact polystyrene (HIPS), polyamides, also known as nylons (PA), acrylonitrile butadiene styrene (ABS), polycarbonate (PC), and polyurethanes (PU). Often these plastic wastes are not recycled with the majority being disposed of in landfills.

Therefore, there is a need for a new system and method for the reuse of coal ash. Preferably this system utilizes recycled materials, such as plastics, is easy to perform, and produces end products that useful and needed.

### SUMMARY OF THE INVENTION

The disclosure of the present invention provides a material composition generally comprised of a recycled CCPs component and a recycled plastic component to form a new material product that can be remolded and reformed into new plastic based products and a method for making the same.

The recycled plastics used within the material composition may include, but are not limited to, polyester (PES), polyethylene terephthalate (PET), polyethylene (PE), high density polyethylene (HDPE), poly vinyl chloride (PVC), polyvinylidene chloride (PVDC), low density polyethylene (LDPE), polypropylene (PP), polystyrene (PS), high impact polystyrene (HIPS), polyamides, also known as nylons (PA), acrylonitrile butadiene styrene (ABS), polycarbonate (PC), and polyurethanes (PU). Any type of CCPs can be used in the combination, although fly ash is preferred.

In an aspect of the disclosure, the product of the above composition of materials is generally formed from the heating of plastics to a melted state, adding in a predetermined quantity of CCPs to the melted plastic, evenly distributing the CCPs into the mixture, and cooling after an even distribution of ingredients is achieved. Water can be added to the mixture after heating to further accelerate the cooling process. After cooling, the newly formed product is shredded for use as a raw base material in additional plastic products.

### BRIEF DESCRIPTION OF THE DRAWING(S)

FIG. 1 shows the method of making a material of recycled coal ash and plastic into a resulting product, according to the present invention.

### DETAILED DESCRIPTION OF THE INVENTION

The following detailed description includes references to the accompanying table of ingredients and diagram of method steps, which form a part of the detailed description. The table shows, by way of a range, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure

The present disclosure provides a method for the reuse and recycling of CCPs and plastics, and more particularly the recycling of coal ash (both fly ash and bottom ash) into a plasticized material.

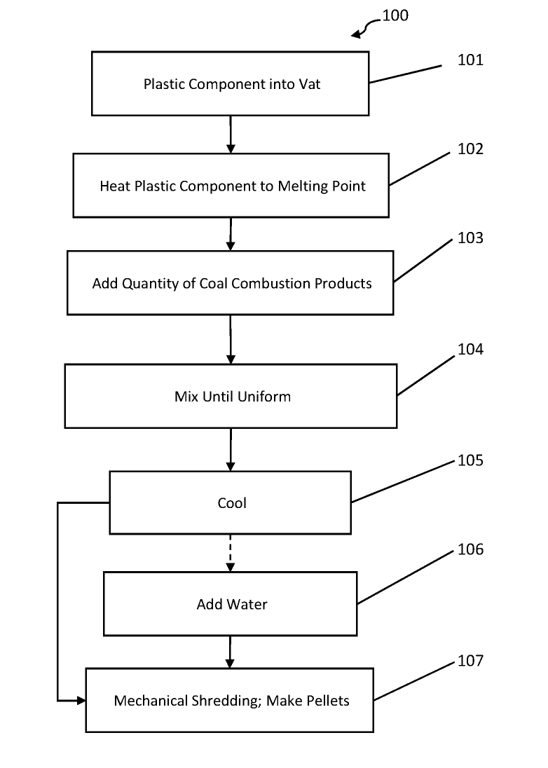

Referring now to FIG. 1, the method 100 allows for the integration of coal ash into a bulk plastic material or plasticized pellets that can be used for molded plastic products. Due to the integration of coal ash into the material, it suggested that resultant products not used for the containment of ingested items, such as food products.

The method 100 generally utilizes coal ash, recycled plastic materials, and heat to create reformed plastic that can be pelletized and reused.

The method 100 utilizes the ingredients of the below TABLE I to recycle CCPs and, more particularly, coal ash into a resultant and reconstituted plastic material. TABLE I provides an exemplary range of ingredients for the method and resultant product according to the present disclosure. This exemplary range of ingredients is capable of producing an end product of plastic material that can be pelletized for additional uses, such as in molded plastic products. This is the preferred range for increased durability of the end product. This exemplary range can be modified with the resultant product created for a specific use. This provided range is anticipated to provide the most useful and durable end product, although other ranges may be utilized.

TABLE I

| Ingredient | Formula Percent |
|---|---|
| 1. Coal Ash | 20-30 |
| 2. Recycled Plastic Materials | 80-70 |
| 3. Water | As Needed for Cooling |

The process of combining the ratios of ingredients as listed in Table 1 is developed to ensure a consistent end product that is capable of being produced in both small-scale and large-scale manufacturing. To produce the end product of plastic pellets utilizing CCPs, a heating vat/vessel and heating source are required.

Method step 101 of the process requires the placement of a predetermined quantity of plastic material into the vat for heating. The plastics used may include, but are not limited to, polyester (PES), polyethylene terephthalate (PET), polyethylene (PE), high density polyethylene (HDPE), poly vinyl chloride (PVC), polyvinylidene chloride (PVDC), low density polyethylene (LDPE), polypropylene (PP), polystyrene (PS), high impact polystyrene (HIPS), polyamides, also known as nylons (PA), acrylonitrile butadiene styrene (ABS), polycarbonate (PC), and polyurethanes (PU). Preferably these plastics are selected from recycled plastic products, such as, milk jugs, plastic bottles, plastic food containers, plastic household items, etc.

Step 102 requires the heating of the quantity of plastic within the vat to a liquid state. The plastics may be melted at a temperature between about 165° F. and 600° F. dependent upon the type of plastics used within the mixture.

Step 103 requires the addition of a predetermined amount of CCPs, such as coal ash, to the liquefied plastic in small batches while mixing to ensure even distribution. The amount of CCPs added to the mixture is preferably at a ratio of 3 parts plastics to 1 part CCPs; 3:1 (plastic to CCPs).

Step 104 requires additional mixing to ensure a uniform and even distribution of materials within the mixture.

Step 105 requires the removal of the liquefied mixture from the heat where the resultant material will solidify into a solid piece of material.

Optional step 106 allows for the addition of water to cool the mixture. The water will remain separated and can be reused.

After cooling and removal of any residual water during the cooling process, the large block of material may be further finished, step 107, through mechanical shredding or palletization into a smaller and more useful size.

In an experiment of the present disclosure, applicant utilized a propane burner and container to heat the plastic to a temperature of approximately 275° F. to 300° F. to a liquid paste, added coal ash while mixing, and evenly distributed the ash into the mixture. The container was removed from the heat, water was added to cool the mixture and the mixture was shaved for reuse.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the specification, claims, and the tables.

What is claimed is:

1. A plastic material, the plastic material comprising:
a plastic component, the plastic component provided in a quantity of between 70% and 80% of a total weight of the plastic material; and
a coal combustion product component, the coal combustion product component provided in a quantity of between 20% and 30% of the total weight of the plastic material, wherein the total amount of the plastic component and coal combustion product component within the plastic material is 100%.

2. A plastic material as in claim 1, wherein the plastic component is selected from the group consisting of polyester, polyethylene terephthalate, polyethylene, high density polyethylene, poly vinyl chloride, polyvinylidene chloride, low density polyethylene, polypropylene, polystyrene, high impact polystyrene, polyamides, also known as nylons, acrylonitrile butadiene styrene, polycarbonate, and polyurethanes.

3. A plastic material as in claim 1, wherein the coal combustion product component is selected from the group consisting of coal ash, boiler slag, and flue gas desulphurization products.

4. A plastic material, the plastic material formed from recycled coal combustion products, the plastic material comprising:
a plastic component; and
a coal combustion product component, the coal combustion product component provided in a ratio of 1:3 of the plastic component (coal combustion product component to plastic component).

5. A plastic material as in claim 4, wherein the plastic component is selected from the group consisting of polyester, polyethylene terephthalate, polyethylene, high density polyethylene, poly vinyl chloride, polyvinylidene chloride, low density polyethylene, polypropylene, polystyrene, high impact polystyrene, polyamides, also known as nylons, acrylonitrile butadiene styrene, polycarbonate, and polyurethanes.

6. A plastic material as in claim 4, wherein the coal combustion product component is selected from the group consisting of coal ash, boiler slag, and flue gas desulphurization products.

7. A method for the reuse of coal combustion products, the method comprising:
heating a plastic to a melting point of the plastic;
adding a coal combustion product to the melted plastic;
mixing the melted plastic and coal combustion product to a uniform distribution; and
cooling the mixture until it is substantially solid.

8. A method for the reuse of coal combustion products as in claim 7, wherein the cooling step comprises the addition of water.

9. A method for the reuse of coal combustion products as in claim 7, wherein the coal combustion products are added to the melted plastic until the ratio of coal composition products to plastic is about 1:3 (coal combustion products to plastic).

10. A method for the reuse of coal combustion products as in claim 7, wherein the plastic is heated within a heat resistant vat and the coal combustion products added to the vat for mixing.

11. A method for the reuse of coal combustion products as in claim 7, wherein the plastic component comprises a maximum of 75% by weight of the end product and the coal combustion products comprise about 25% by weight of the end product.

12. A method for the reuse of coal combustion products as in claim 7, comprising the additional step of pelletizing the solid mixture after cooling.

13. A method for the reuse of coal combustion products as in claim 7, wherein the plastic component is selected from the group consisting of polyester, polyethylene terephthalate, polyethylene, high density polyethylene, poly vinyl chloride, polyvinylidene chloride, low density polyethylene, polypropylene, polystyrene, high impact polystyrene, polyamides, also known as nylons, acrylonitrile butadiene styrene, polycarbonate, and polyurethanes.

14. A method for the reuse of coal combustion products as in claim 7, wherein the coal combustion products are selected from the group of consisting of coal ash, boiler slag, and flue gas desulphurization products.
